(19) United States
(12) Patent Application Publication
(10) Pub. No.: US 2012/0192531 A1
(43) Pub. Date: Aug. 2, 2012

(54) SADDLE AIR FLOW SYSTEM

(76) Inventor: Ronald Efrain Zabala-Goetschel, Quito (EC)

(21) Appl. No.: 13/016,058

(22) Filed: Jan. 28, 2011

(51) Int. Cl. B68C 1/02

(52) U.S. Cl. 54/44.1

(57) ABSTRACT

An equestrian saddle that facilitates air flow includes a seat having at least one seat channel that extends through the seat, at least one air channel disposed in one or more panels, or one or more flap apertures. When used in combination, the seat channel, air channels, and flap apertures form a saddle air flow system. This system provides for air flow within and under the saddle, particularly during inhalation and exhalation of a horse, certain atmospheric conditions, and movement of a horse. The system thus provides for ventilation and cooling of rider and horse.

### BACKGROUND OF THE INVENTION

1. Field of the Invention

The present invention relates to equestrian saddles, particularly equestrian saddles and saddle air flow systems.

2. Background

During equestrian events, recreation, training, and exercising, among other activities, both riders and horses generate body heat. The amount of body heat generated depends upon several factors, including, but not limited to, atmospheric conditions, the overall fitness of rider and horse, and the rigorous nature of the event. Another source of body heat—not often considered by saddle manufacturers—is frictional heat generated by the interaction between a saddle, rider and horse. Regardless of the source of body heat generated during these types of activities, less heat, particularly during riding, can benefit both rider and horse.

Riders of conventional equestrian saddles are known to generate excessive heat and perspiration, particularly in body regions in contact with a saddle. Excessive heat and perspiration in these areas, however, can contribute to health problems. Known problems include, but are not limited to, odor, fungi formation, dehydration, chafing, inflammation, numbness, genital acne, heat rashes, and hemorrhoids. In addition, for male riders, problems relating to testicular and prostrate health can result. In extreme cases, excessive heat and friction in the groin area can further result in fertility problems, particularly for male riders.

Horses also generate excessive heat and perspiration due to, among other things, the frictional interaction between a saddle, rider, and horse. Dehydration of the horse can, in some cases, affect an animal's ability to perform at optimum levels. Muscles of the horse, especially those in contact with the underside of the saddle, can fatigue due to excessive heat and perspiration. In addition, under certain conditions a horse may develop skin conditions that may later affect the overall health of the horse.

In view of the potential health problems—for both rider and horse—and concerns noted, a clear need exists for improved equestrian saddles and saddle air flow systems.

### SUMMARY OF THE INVENTION

The present invention is directed toward equestrian saddles and saddle air flow systems that facilitate air flow, through the use of channels and apertures. In one aspect, the saddle includes a seat having at least one seat channel that extends through the seat. The channel is positioned in the seat such that air flow is directed under the seat, providing for additional air flow near the rider's groin area. In another aspect, the saddle includes a flap having apertures that facilitate air flow. In another aspect, the saddle incorporates air channels placed within one or more panels. These air channels direct air flow through the panels from a variety of sources. Such source include, but are not limited to, air flow resulting from the inhalation and exhalation of a horse, atmospheric conditions, e.g. wind, and movement of a horse, e.g. galloping.

In a separate aspect, when used in combination, at least one seat channel, air channel, and flap aperture operate as a saddle air flow system. The system provides for air flow that surrounds the saddle, providing for ventilation and cooling of rider and horse.

Accordingly, an equestrian saddle and saddle air flow system are disclosed. Advantages of the equestrian saddle and saddle air flow system will appear from the drawings and detailed description.

### BRIEF DESCRIPTION OF THE DRAWINGS

FIG. 1 is a bottom perspective view of an equestrian saddle, illustrating a saddle air flow system;

FIG. 2 is a top perspective view of the equestrian saddle shown in FIG. 1;

FIG. 2A is an enlarged view of the panel shown in FIG. 2;

FIG. 2B is an enlarged view of an another panel, illustrating a type of cap;

FIG. 3 is a left side view of the equestrian saddle shown in FIG. 1 positioned on a horse with rider;

FIG. 4 is a left side perspective view of the equestrian saddle shown in FIG. 1; and

FIG. 5 is a left side perspective view of another equestrian saddle, illustrating a saddle air flow system;

### DETAILED DESCRIPTION

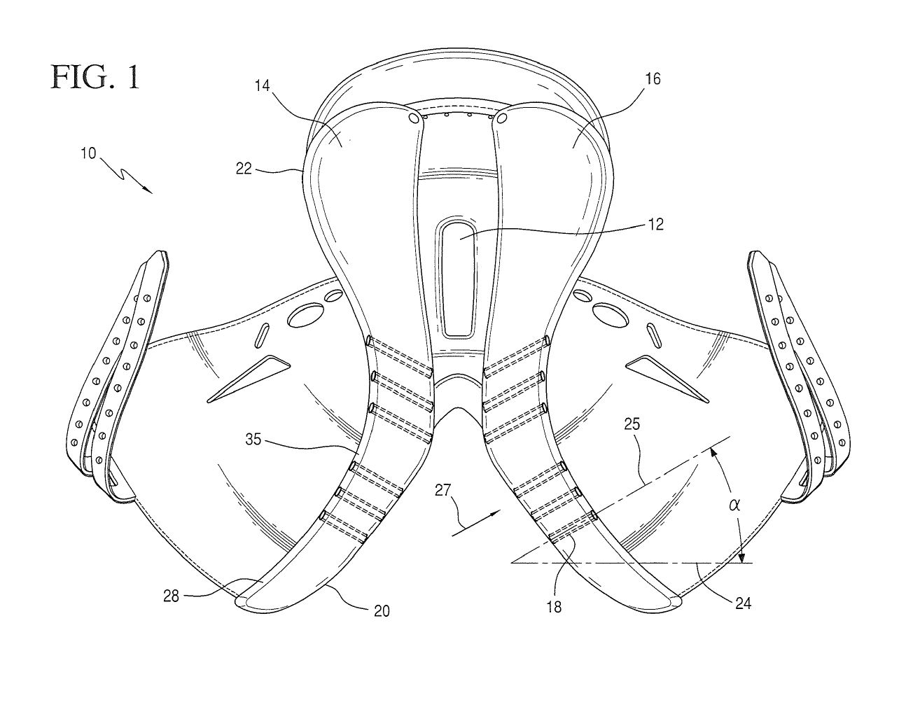

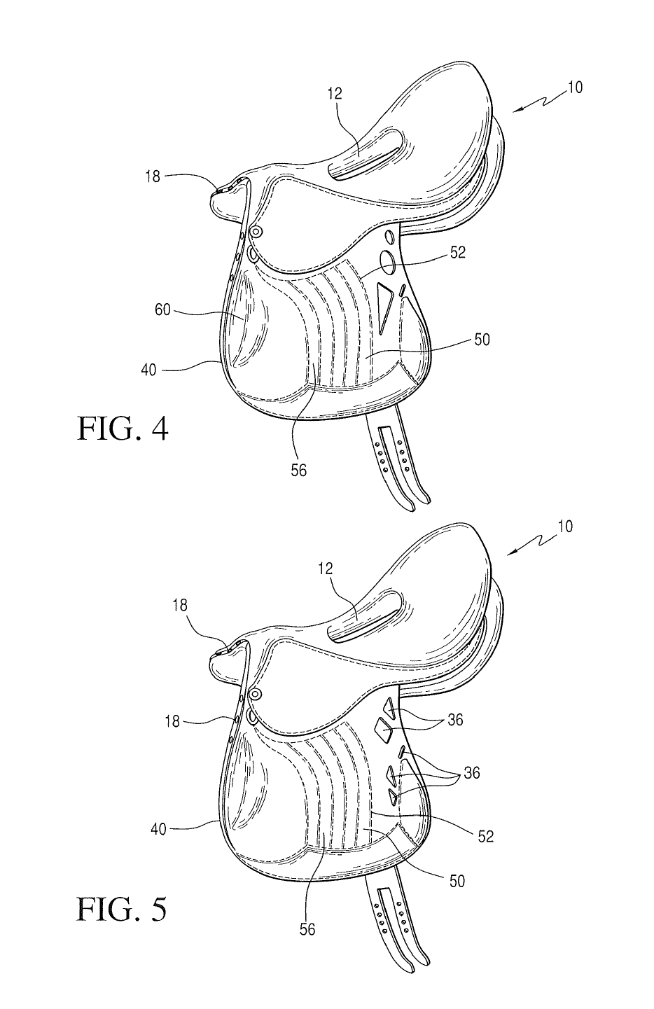

Turning in detail to the drawings, FIGS. 1-5 illustrate an equestrian saddle 10. The term “equestrian saddle,” as used herein, is defined as a saddle used for a horse or other animal, for purposes of riding. Saddle types include, but are not limited to, saddles used for recreational use and equestrian events of any type. Such events include jumping, show jumping, cross country, endurance, dressage, reining, barrel racing, quarter horse competition, thoroughbred racing, and other types of horse racing.

The saddle 10 is preferably made from leather, particularly leather that is capable of manufacture in any color. Other suitable materials for saddle manufacture, however, may be used. The equestrian saddle 10 is preferably designed for use with a changeable gullet (not shown).

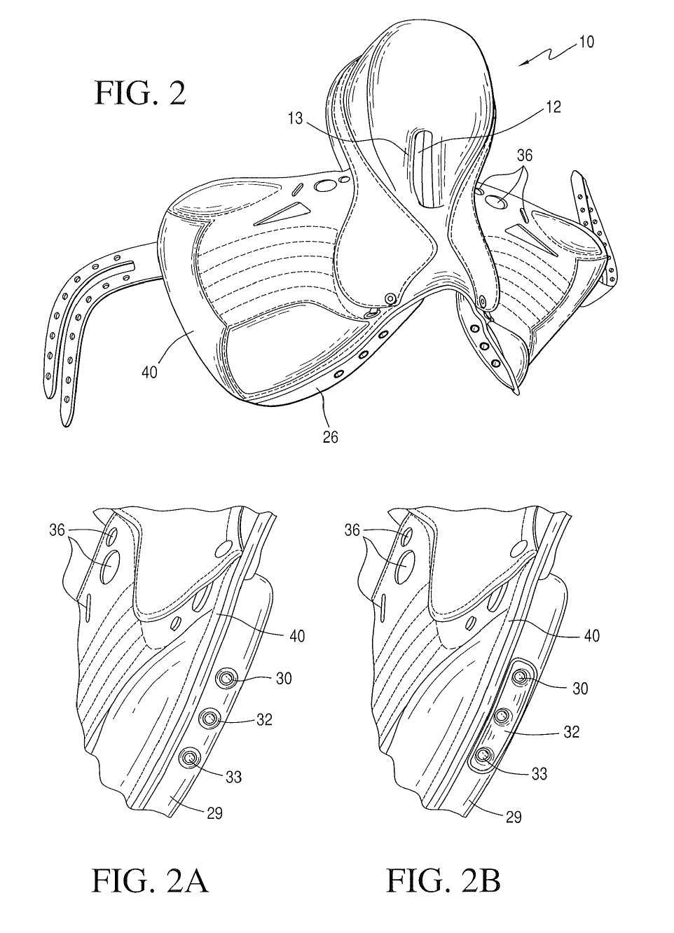

The equestrian saddle 10 includes a seat channel 12 that extends through the seat to facilitate air flow. In this configuration, the seat channel 12 is elongated with rounded edges 13 and is adapted to extend through the seat. The seat channel 12 is preferably positioned between two panels 14, 16. In addition, the seat channel 12 is designed to have rounded edges 13 such that pressure is alleviated from a rider's groin area 11, as shown in FIG. 2. The seat channel, however, may have any other configuration which facilitates air flow.

As illustrated in FIG. 1, one or more panels 14, 16 may be provided with at least one air channel 18. In this configuration, two panels 14, 16 are provided each with six channels. Three of these channels are disposed closer to a pommel region 20. The other three channels are disposed closer to a cantle region 22. Each air channel 18 extends fully through a panel. The channel can have a circular cross section or a cross section of any other shape. In addition, along the length of the channel, the cross sectional shape may vary. Where a circular cross section is used, the air channel 18 preferably has a diameter ranging between about 2 millimeters and about 25 millimeters.

The air channel 18 can extend at an angle α through one or more panels 14, 16. In one configuration of the air channel 18, as shown in FIG. 1, the angle a can range from 0 degrees to 45 degrees, when taken from a first theoretical axis 24 to a second theoretical axis 25. Each air channel 18 extends from a first side 26 of a panel to a second side 28, such that air flows through the channel, providing ventilation for both rider and horse. This air flow can result from a variety of sources, including the inhalation and exhalation of a horse, atmospheric conditions, and movement of a horse.

As shown in FIG. 2A, disposed within each air channel 18 are pipettes 30. Each pipette 30 is designed to further facilitate air flow within the panel, providing for additional air flow in a direction 27 through the panel, as indicated in FIG. 1. Each pipette 30 is secured to the air channel 18 using a press fit, an adhesive, or other fastening method. Each air channel 18 and pipette 30 are designed to facilitate air flow. For example, when a horse inhales and exhales, a thrust of air is directed through the air channel 18 and pipette 30, allowing for ventilation and reduction in body temperature of both rider and horse.

As further shown in FIG. 2A, on at least one end 29 of the air channel 18, a cap 32 may be provided. In this configuration, a cap 32 is provided on a first side 33, providing in part, aesthetic value. The cap 32 may also be provided on a second side 35 (shown in FIG. 1). In FIG. 2A, the cap 32 is shown with a through-hole 33. In addition to this cap, a cover 34 (not shown) may be provided. This cover 34 can be used during the storage of the equestrian saddle 10 to prevent the accumulation of debris or other matter within the air channel 18. The cap 32 or the cover 34 is secured to the air channel 18 using a press fit, an adhesive, or other fastening means. FIG. 2B illustrates another cap configuration, showing the cap 32 such that is extends coverage to three air channels. This type of cap may, however, extend to cover few or more channels.

FIGS. 1-5 further illustrate at least one flap aperture 36 disposed on a flap 40. These flap apertures 36 facilitate air flow under the flaps 40. The flap apertures 36 may be any shape. In the configurations shown, the flap apertures have circular, triangular, and rectangular shapes. Further, for aesthetic reasons the apertures may be formed to represent a logo or other identifying indicia.

When used in combination, at least one seat channel 12, at least one air channel 18, and at least one flap aperture 36 operate as a saddle air flow system 70, such as the WISAIR™ saddle air flow system. The system provides for air flow that surrounds the saddle, particularly within and under the saddle 10. Air flow is facilitated during the inhalation and exhalation of a horse, certain atmospheric conditions, e.g. wind, and movement of a horse, e.g. galloping. Under these, among other types of conditions, air flows through the air channels 18, the flap apertures 36, and the seat channel 12. The combination of channels and apertures forms a system that provides for ventilation and cooling for both rider and horse.

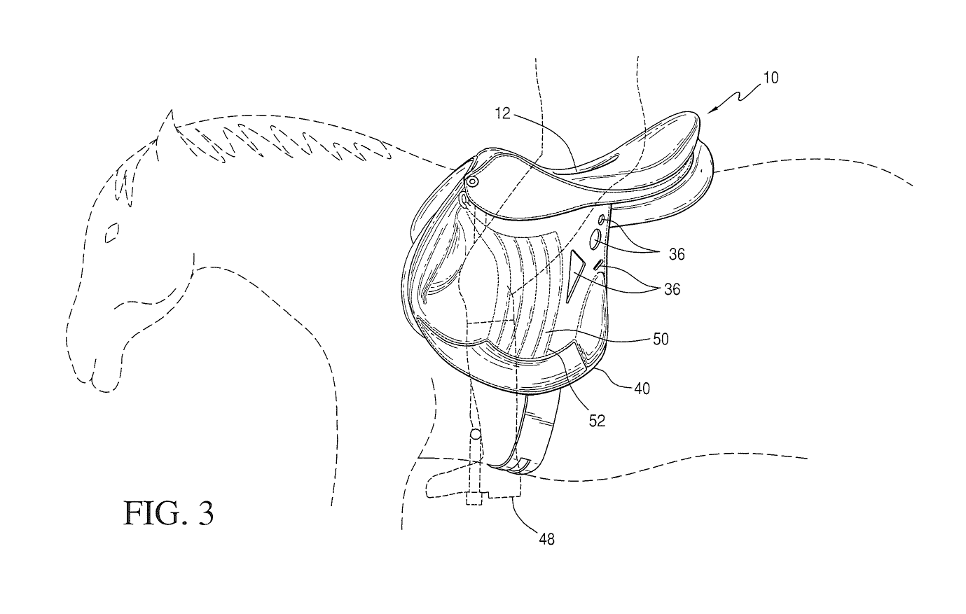

As shown, for example, in FIG. 3, in addition to the aforementioned features, an equestrian saddle 10 may be provided with one or more leg stabilization areas 50. The leg stabilization area 50 is disposed on one or more flaps 40. Under a saddle covering 60, preferably made of leather, the stabilization areas 50 are filled with a padding material 54 (not shown). The padding material 54 is preferably sponge-like and can include foams, rubbers, or other types of padding materials. The leg stabilization areas 50 are bounded by stitching 52. Stitching, as used herein, is broadly defined as any type of technique used for containment of the padding to a pre-determined area. The combination of the stitching 52 and padding material 54 creates one or more stabilization regions 56. These regions are raised. Therefore, when used by a rider, interference occurs between these regions 56 and a rider's leg 48, stabilizing the upper thigh and the leg region that extends from the rider's ankle to the rider's knee.

Thus, an equestrian saddle and a saddle air flow system are disclosed. While embodiments of this invention have been shown and described, it will be apparent to those skilled in the art that many more modifications are possible without departing from the inventive concepts herein. The invention, therefore, is not to be restricted except in the spirit of the following claims.

1. An equestrian saddle comprising:
a seat having at least one seat channel that facilitates air flow, wherein the at least one seat channel extends through the seat.

2. The equestrian saddle according to claim 1, further comprising a panel coupled to the seat, wherein the panel has at least one air channel.

3. The equestrian saddle according to claim 2, wherein a pipette is disposed within the at least one air channel.

4. The equestrian saddle according to claim 2, further comprising a cap coupled to the at least one air channel.

5. The equestrian saddle according to claim 1, further comprising at least one flap having at least one flap aperture, wherein the at least one flap is coupled to the seat.

6. The equestrian saddle according to claim 5, wherein the at least one flap aperture has a geometric shape.

7. The equestrian saddle according to claim 6, wherein the geometric shape is selected from the group consisting of circles, triangles, and rectangles.

8. The equestrian saddle according to claim 1, wherein the at least one seat channel is elongated.

9. The equestrian saddle according to claim 1, further comprising a leg stabilization area.

10. A saddle air flow system comprising:
at least one seat channel disposed within a seat;
at least one channel disposed within a panel, wherein the panel is coupled to the seat; and
at least one aperture disposed on a flap, wherein the flap is coupled to the seat.

11. An equestrian saddle comprising
at least one flap having a plurality of leg stabilization areas, wherein each leg stabilization area comprises:
a covering disposed on the flap;
padding disposed under the covering; and
stitching that surrounds a portion of the covering and padding to form a raised stabilization region.
